(19) United States
(12) Patent Application Publication
(10) Pub. No.: US 2017/0046332 A1
(43) Pub. Date: Feb. 16, 2017

(54) MULTI-MEDIA COMMUNICATIONS RECORDING SYSTEM

(71) Applicant: SILENTPARTNER RECORDING LLC, Manahawkin, NJ (US)

(72) Inventor: Christopher Anthony SILVA, Manahawkin, NJ (US)

(21) Appl. No.: 14/824,784

(22) Filed: Aug. 12, 2015

(51) Int. Cl. G06F 17/28; H04N 5/913; H04N 21/439; H04N 21/422; H04N 21/4223; H04N 5/77; H04N 21/2743

(52) U.S. Cl. CPC G06F 17/289; H04N 5/77; H04N 5/913; H04N 21/2743; H04N 21/42203; H04N 21/4223; H04N 21/439; H04N 2005/91335; H04N 2005/91364

(57) ABSTRACT

The present invention relates to a multimedia capture device on a mobile platform that captures information from manual input as well as environmental variables, and is able to package the information and send the information to a storage medium for archival. A user interface provides a one touch access for a user to connect a speakerphone of the mobile platform to a universal language translation application module or service provider to allow the user to communicate with someone they previously couldn't because of the language barrier.

### BACKGROUND OF THE INVENTION

Field of the Invention

The present invention relates to an integrated communications recording system including a user interface having a one touch feature which enables the interface to connect to a translation service, and thereafter uses the speakerphone to speak the translated information as well as have subsequent speech recorded by the speakerphone and also have video and photographs from the phone recorded and stored.

Description of Related Art

Systems which record conversations of calls are known. U.S. Pat. No. 8,428,559 describes data recording a mobile phone call conversation in which an incoming or outgoing call is automatically conferenced to a centralized recording server and audio from the internal call can be captured and stored. Any data or messages presented independently of the audio is also delivered to the recording server. For example, the messages can include short message service (SMS) messages and multimedia messaging (MMS) messages. Also, other message types using for example text, pictures or video utilized by the mobile phone can be delivered to the recording server.

Conventionally a police officer can carry a pocket tape recorder for interviews/statements, a camera to take photos, a device to announce a pre-recorded message in multiple languages, such as Miranda rights, and video to record the interaction. Thereafter, the police office can plug in the camera, tape recorder, and video device to various interfaces in order to manually copy and store data from the devices.

It is desirable to provide an improved multimedia capture device on a mobile platform having an interface to a translation provider to translate commands or a conversation and to record the conversation along with environmental and manually entered data all while eliminating the need for the user, such as for example a police officer, to manage the media collected.

### SUMMARY OF THE INVENTION

The present invention relates to a multimedia capture device on a mobile platform that captures information from manual input as well as environmental variables, and is able to package the information and send the information to a storage medium for archival and retrieval. In one embodiment, a user interface provides a one touch access for a user to connect a speakerphone of the mobile platform to a universal language translation application module or service provider to allow the user to communicate with someone they previously couldn't because of the language barrier. The conversation of the mobile platform is recorded along with environmental and manually entered data. In one embodiment, the information recorded includes one or more of photographs and video. The present invention has the advantage that it eliminates the need for a person, such as a police officer, to carry a pocket tape recorder for interviews or statements, a camera to take photos, a device to announce a pre-recorded message in multiple languages, such as Miranda rights.

The invention will be more fully described by reference to the following drawings.

### BRIEF DESCRIPTION OF THE DRAWINGS

FIG. 1 is a schematic diagram of multi-media communications recording system.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

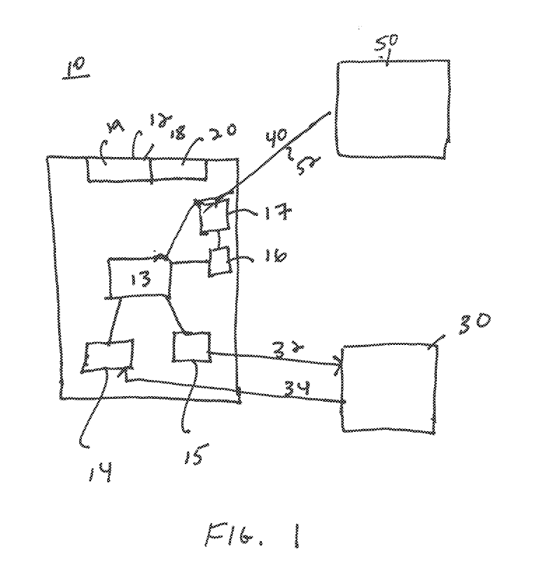

FIG. 1 is a schematic diagram of a multi-media communications recording system 10. Mobile platform 12 includes operating system 11, multi-media communications recording application module 13, speaker 14, micro-phone 15, memory storage module 16 and local storage 17. Memory storage module 16 and local storage typically include or are provided with a variety of computer-readable media. Computer-readable media can be any available media and includes both volatile and non-volatile media, removable and non-removable media. By way of example, and not limitation, computer-readable media may include computer storage media and communication media. Computer storage media includes, but is not limited to, RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, or any other medium which can be used to store the desired information.

Mobile platform 12 can be a mobile phone. Alternatively, mobile platform 12 can be a tablet, tablet PC or other hand-held multi-media recording device. Suitable operating systems 11 include Android™, Symbian®, Apple iOS™, RIM BlackBerry®, MeeGo®, Windows® Phone and Bada. Mobile platform 12 contains one or more speakers 14 and microphones 15 or allows the connection of remote microphones and speakers via wireless technology such as Bluetooth, to interface with operating system 11 of the mobile platform 12 as well as multi-media communications recording application module 13 that runs on operating system 11. Mobile platform 12 can include camera interface 18 for capturing video 19 or photographs 20 with mobile platform 12.

User interface 25 of mobile platform 12 can interface with multi-media recording application module 13. User interface 25 can interact with multi-media communications recording application module 13 to establish communications to be recorded from micro-phone 15 of mobile platform 12 and associated entered data including video 19 and photographs 20.

Multi-media recording application module 13 can establish communications with universal language translation module 30. Universal language translation module 30 can receive audio data 32 from micro-phone 15 of mobile platform 12. Universal language translation module 30 can translate received audio data 32. Translated data 34 from universal translation module 30 can be played at speaker 14 of mobile platform 12. Universal language translation module can be performed with an applications such as for example GOOGLE Translate or by a third party service provider.

Multi-media recording application module 13 can capture an audio stream or packets from micro-phone 15 compress the audio stream or packets and store the one or more files for captured audio stream or audio packets in local storage 17 using memory storage module 16. Multi-media recording application module 13 can include software for digital watermarking, fingerprinting and encryption. One or more captured audio and/or data files 40 from multi-media recording application module 13 can be securely streamed or transferred to the one or more third-party recorder databases 50 over wireless connection 52. After verification of the transfer to third-party recorder databases 50 captured audio and/or data files 40 can be deleted from local storage 17 using memory storage module 16.

Embodiments of the present invention may be implemented in connection with a special purpose or general purpose telecommunications device that include both hardware and/or software components, including wireless telephones and other telephony-enabled wireless devices, landline telephones, or special purpose or general purpose computers that are adapted to have telecommunications capabilities.

Embodiments may also include physical computer-readable media and/or intangible computer-readable media for carrying or having computer-executable instructions, data structures, and/or data signals stored thereon. Such physical computer-readable media and/or intangible computer-readable media can be any available media that can be accessed by a general purpose or special purpose computer. By way of example, and not limitation, such physical computer-readable media can include RAM, ROM, EEPROM, CD-ROM or other optical disk storage, magnetic disk storage or other magnetic storage devices, other semiconductor storage media, or any other physical medium which can be used to store desired data in the form of computer-executable instructions, data structures and/or data signals, and which can be accessed by a general purpose or special purpose computer. Within a general purpose or special purpose computer, intangible computer-readable media can include electromagnetic means for conveying a data signal from one part of the computer to another, such as through circuitry residing in the computer.

When information is transferred or provided over a network or another communications connection (either hardwired, wireless, or a combination of hardwired or wireless) to a computer, hardwired devices for sending and receiving computer-executable instructions, data structures, and/or data signals (e.g., wires, cables, optical fibers, electronic circuitry, chemical, and the like) should properly be viewed as physical computer-readable mediums while wireless carriers or wireless mediums for sending and/or receiving computer-executable instructions, data structures, and/or data signals (e.g., radio communications, satellite communications, infrared communications, and the like) should properly be viewed as intangible computer-readable mediums. Combinations of the above should also be included within the scope of computer-readable media.

Computer-executable instructions include, for example, instructions, data, and/or data signals which cause a general purpose computer, special purpose computer, or special purpose processing device to perform a certain function or group of functions. Although not required, aspects of the invention have been described herein in the general context of computer-executable instructions, such as program modules, being executed by computers, in network environments and/or non-network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

Embodiments may also include computer program products for use in the systems of the present invention, the computer program product having a physical computer-readable medium having computer readable program code stored thereon, the computer readable program code comprising computer executable instructions that, when executed by a processor, cause the system to perform the methods of the present invention.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A multi-media communications recording system comprising:
a mobile platform including a microphone, a speaker and a camera interface, and
a multi-media communications recording application module interfacing with the microphone, the speaker and the camera interface;
said multi-media communications recording application module interfacing with a storage module for recording and storing data from said microphone and said camera interface.

2. The system of claim 1 wherein the data is audio data from said microphone and said multi-media communications recording application is configured for compressing the audio data into a waveform audio format.

3. The system of claim 2 wherein the multi-media communications recording application is further configured for encrypting the audio data.

4. The system of claim 2 wherein the multi-media communications recording application is further configured for fingerprinting the audio data.

5. The system of claim 1 wherein the multi-media communications recording application is further configured for transferring stored data to a third party recorder database.

6. The system of claim 5 wherein the multi-media communications recording application is further configured for deleting the audio data from a local memory storage of the mobile platform after verification of the transfer of the stored audio.

7. The system of claim 1 wherein the mobile platform is a mobile phone.

8. The system of claim 1 wherein the mobile platform is a tablet.

9. The system of claim 1 further comprising a user interface to interface the multi-media recording application module to establish the data to be recorded from the micro-phone and the camera interface.

10. The system of claim 1 wherein the camera interface captures video or photographs.

11. The system of claim 1 further comprising a universal translation module communicating with said multi-media communications recording application module, said universal language translation module translating the data from the microphone and said multi-media communications recording application module interfacing with said speaker for playing of the translated data from the universal language translation module.

12. The system of claim 11 further comprising a user interface to interface the multi-media recording application module to establish the data to be recorded from the micro-phone and the camera interface and the universal language translation module.

13. A multi-media communications recording system comprising:
a mobile platform including a microphone, a speaker and a camera interface, and
a multi-media communications recording application module interfacing with the microphone, the speaker and the camera interface;
a universal translation module communicating with said multi-media communications recording application module, said universal language translation module translating data from the microphone and said multi-media communications recording application module interfacing with said speaker for playing of the translated data from the universal language translation module
said multi-media communications recording application module interfacing with a storage module for recording and storing the data from said microphone and data from said camera interface.

14. The system of claim 13 further comprising a user interface to interface the multi-media recording application module to establish the data to be recorded from the micro-phone and the camera interface and the universal language translation module.

15. The system of claim 13 wherein the multi-media communications recording application is further configured for transferring stored data to a third party recorder database.

16. The system of claim 15 wherein the multi-media communications recording application is further configured for deleting the audio data from a local memory storage of the mobile platform after verification of the transfer of the stored audio.

17. The system of claim 1 wherein the mobile platform is a mobile phone.

18. The system of claim 1 wherein the mobile platform is a tablet.

19. The system of claim 13 wherein the camera interface captures video or photographs.
